(19) United States
(12) Patent Application Publication
(10) Pub. No.: US 2006/0251009 A1
(43) Pub. Date: Nov. 9, 2006

(54) Wireless communication system for providing multiple user Internet access

(75) Inventors: John Thommana, Austin, TX (US); Ravikumar V. Pragada, Collegeville, PA (US); Tex Nichols, Sherrills Ford, NC (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/181,658

(22) Filed: Jul. 14, 2005

Related U.S. Application Data
(60) Provisional application No. 60/677,287, filed on May 3, 2005.

(51) Int. Cl. H04Q 7/00; H04L 12/66; H04L 12/56; H04L 12/28

(52) U.S. Cl. 370/328; 370/400; 370/352

(57) ABSTRACT

A wireless communication system which provides a plurality of wireless transmit/receive unit (WTRU) users with access to the Internet via a wireless local area network (WLAN), Bluetooth™ or ultra-wideband (UWB) interface. The system includes a short-range access point (AP) in communication with the WTRUs, multiplexer in communication with the Internet and the AP, and a plurality of mobile platforms in communication with the multiplexer and the Internet. The system may further include a mapping unit for correlating routable medium access control (MAC) addresses to specific universal serial bus (USB) interfaces associated with the mobile platforms. The system may be incorporated in a mass-transit vehicle, whereby the WTRU users are passengers in the vehicle.

### CROSS REFERENCE TO RELATED APPLICATION

This application claims the benefit of U.S. Provisional Application No. 60/677,287, filed May 3, 2005, which is incorporated by reference as if fully set forth herein.

### FIELD OF INVENTION

The present invention is related to a wireless communication system which provides a plurality of wireless transmit/receive unit (WTRU) users with access to the Internet via a wireless local area network (WLAN), Bluetooth™ or ultra-wideband (UWB) interface. More particularly, the present invention is related to a smart multiplexer used to map medium access control (MAC) addresses to specific universal serial bus (USB) interfaces to provide the WTRU users with Internet access.

### BACKGROUND

Ultra-wideband (UWB) is gaining popularity as the next personal area networking technology. The key advantages that give it a better chance at success is the extremely high data rates supported, (i.e., 100-480 Mbps), at considerably lower power budgets.

The next generation of mobile platforms can accept Internet access connections from trusted WTRUs in mass-transit vehicles such as cars, buses and trains over a UWB interface.

Local access can be provided on mass-transit vehicles by using IEEE 802.11 based access points (APs). However, a feasible mechanism currently does not exist for connecting a plurality of mobile WTRU users to the Internet in a mass-transit vehicle.

### SUMMARY

The present invention is related to a wireless communication system which provides a plurality of WTRU users with access to the Internet via a WLAN, Bluetooth™ or UWB interface. The system includes a short-range AP in communication with the WTRUs, multiplexer in communication with the Internet and the AP, and a plurality of mobile platforms in communication with the multiplexer and the Internet. The system may further include a mapping unit for correlating routable MAC addresses to specific USB interfaces associated with the mobile platforms. The system may be incorporated in a mass-transit vehicle, whereby the WTRU users are passengers in the vehicle.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a smart multiplexer and an external WLAN AP which are configured to provide WTRU users with access to the Internet in accordance with the present invention;

FIG. 2 is a block diagram of a system which incorporates the features of the smart multiplexer and the external WLAN of FIG. 1 for providing Internet access on mass-transit vehicles using a USB hub and a plurality of U100 slaves in accordance with the present invention;

FIG. 3 is a block diagram of a system similar to the system of FIG. 2 except that a WLAN AP is embedded in the U100 master;

FIG. 4 is a block diagram of a system similar to the system of FIG. 2 except that it includes a Bluetooth™ gateway in the U100 master; and

FIG. 5 is a block diagram of a system similar to the system of FIG. 2 except that it includes a UWB gateway in the U100 master.

### DETAILED DESCRIPTION OF THE PREFERRED EMBODIMENTS

Hereafter, the terminology “WTRU” includes but is not limited to a user equipment (UE), a mobile station, a laptop, a personal data assistant (PDA), a fixed or mobile subscriber unit, a pager, or any other type of device capable of operating in a wireless environment. When referred to hereafter, the terminology access point (AP) includes but is not limited to a base station, a Node-B, a site controller, an access point or any other type of interfacing device in a wireless environment.

The features of the present invention may be incorporated into an integrated circuit (IC) or be configured in a circuit comprising a multitude of interconnecting components.

The present invention implements a mobile platform as an Internet gateway in closed short-range mobile applications. Typical usage scenarios envisaged are in private and public transportation vehicles.

A mobile platform, such as the Ericsson Mobile Platform U100, can access the Internet using a global system for mobile communications (GSM)/general packet radio service (GPRS) interface or the Third Generation (3 G) interface. The Ericsson Mobile Platform U100 is dual-mode enabled, and supports both GSM/GPRS and WCDMA. Connectivity for U100 is currently provided by Bluetooth™, USB, RS232, and infrared data association (IrDA).

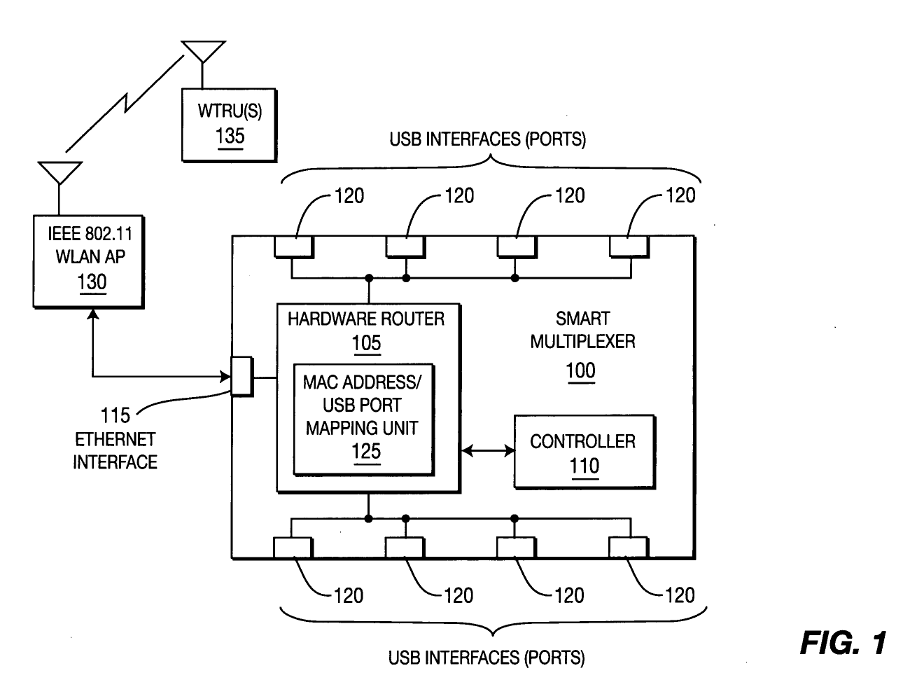

FIG. 1 is a block diagram of a smart multiplexer 100 which is configured to provide a plurality of WTRU users access to the Internet in accordance with the present invention. The smart multiplexer 100 includes a hardware router 105 and a controller 110 which controls the hardware router 105. The controller 100 acts based on the intelligence provided internally, as to which users need to be authenticated and accepted, or based on connection to an external device such as an AAA server. The smart multiplexer includes an Ethernet interface 115 and a plurality of USB interfaces (ports) 120. The Ethernet interface 115 is provided to connect the hardware router 105 to the WLAN AP 130. The number of USB interfaces 120 included in the smart multiplexer 100 dictates the number of mobile platforms, (i.e., U100 devices), that may be connected to the smart multiplexer 100 via a USB interface (port) 120, and the associated data rate requirements.

The hardware router 105 includes a MAC address/USB port mapping unit 125. The Ethernet connection 115 of the smart multiplexer 100 is connected to a WLAN AP 130, which may be IEEE 802.11 compatible. When a WTRU user, (located in a mass-transit vehicle in which the smart multiplexer 100 is installed), wishes to connect to the Internet, the WTRU sends a request to the WLAN AP 130 which is connected to the Ethernet connection 115 of the smart multiplexer 100. The MAC address of the user is received by the hardware router, which forwards the MAC address to a corresponding USB interface/port 120 to which a specific U100 device is connected.

Each U100 in a WCDMA 3G network can support up to 384 kbps data rate (macro cell). A WLAN/UWB/Bluetooth™ user is provided this bandwidth via a specific U100 and is mapped to a particular USB port. This way, there is no confusion as to where particular user traffic has to be routed in the smart multiplexer 100. The hardware router 105 inputs the MAC address into the mapping unit 125 which includes a routing table, (see Table 1 below), that correlates routable MAC addresses to respective USB interfaces 120.

TABLE 1

| User MAC Address | Associated USB port |
|---|---|
| MAC Address #1 | USB Port #1 |
| MAC Address #2 | USB Port #2 |
| MAC Address #3 | USB Port #3 |
| . . . | |
| . . . | |
| MAC Address #n | USB Port #n |

If the MAC address is not found in the routing table of Table 1, the hardware router 105 sends the MAC address to the controller 110, which authenticates and authorizes the user depending on the information, either stored locally in the smart multiplexer 100 or by accessing an external server, such as an authentication, authorization, and accounting (AAA) server. The controller 110 selects a USB interface 120 and its associated U100 over which traffic will be routed to and from the Internet. The controller 110 also sends the MAC address of this user to be added in the routing table of the mapping unit 125 of the hardware router 105. From then on, any traffic for this MAC address will be routed by the hardware router 105 to the corresponding USB interface 120 without the intervention of the controller 110.

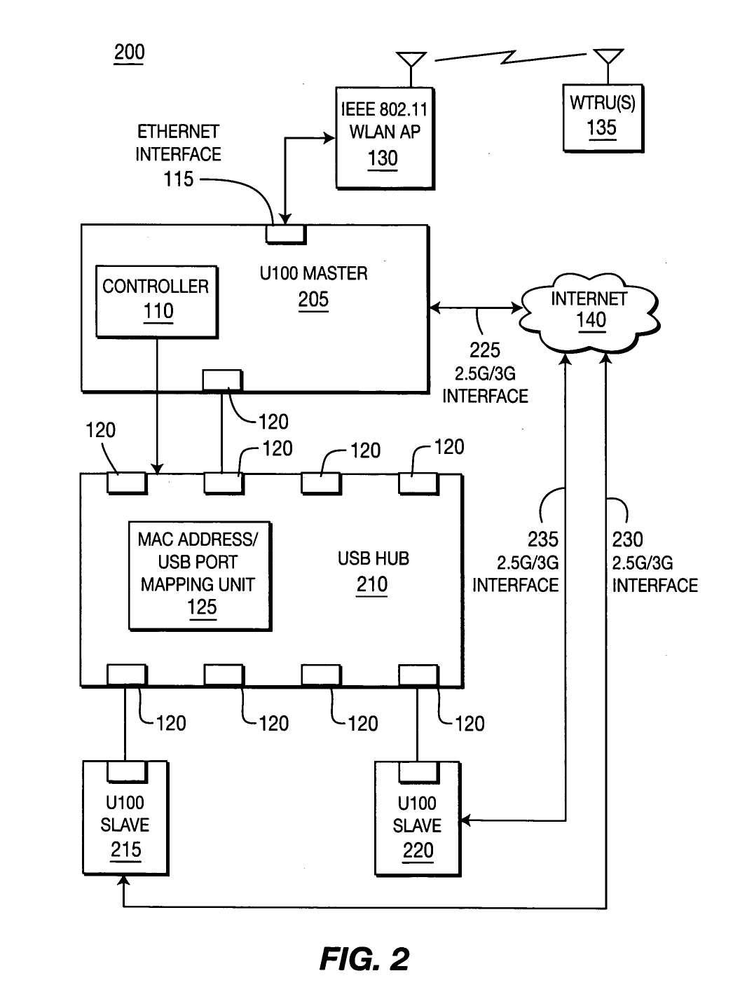

FIG. 2 is a block diagram of a system 200 which incorporates the features of the smart multiplexer 100 and the external WLAN 130 of FIG. 1 for providing Internet access. The system 200 includes a U100 master 205, a USB hub 210 and a plurality of U100 slaves 215, 220 in accordance with the present invention. The U100 platform connectivity is extended by adding Ethernet interfaces to it in the case of U100 master 205. Also, a software module, (i.e., the controller 110), is incorporated into the U100 master 205. No modifications are needed to the U100 slaves 215, 220. There is no relationship between the WTRU(s) 135, the U100 master 205 and the U100 slaves 215, 220, except for the fact that each WTRU traffic path is routed through a particular U100 slave 215, 220.

The system 200 incorporates the features of the smart multiplexer 100 of FIG. 1 for providing Internet access, such as on mass-transit vehicles. A controller 110 in the U100 master 205 dictates how the USB hub 210 should behave. The mapping unit 125 is located in the USB hub and operates in the same fashion described above.

The data rates supported by 2.5 G/3 G networks for the U100 master 205 and the U100 slaves 215, 220 is the rate limiting factor. The highest data rate in a 3 G network macro cell is 384 kbps, which is not sufficient for supporting multiple WLAN/UWB/Bluetooth™ data rates. Thus, the present invention uses the USB hub 210 and a plurality of U100 slaves 215, 220 such that traffic can be routed either through path 225 or paths 230, 235 as long these paths are not currently assigned to an existing WLAN/UWB/Bluetooth™ user (i.e., WTRU 135). The path between the U100 master 205 to the USB hub 210 is through a USB interface 120 to facilitate communication therebetween.

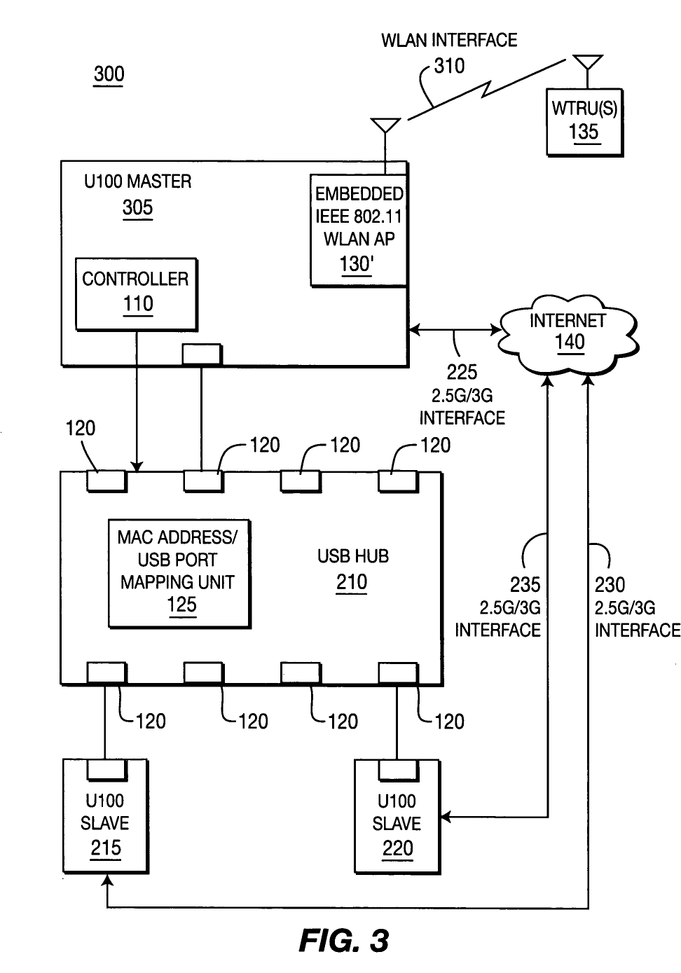

FIG. 3 is a block diagram of a system 300 similar to the system 200 of FIG. 2 except that a WLAN AP 130′ is embedded in a U100 master 305 to provide a WLAN interface 310 for at least one WTRU 135.

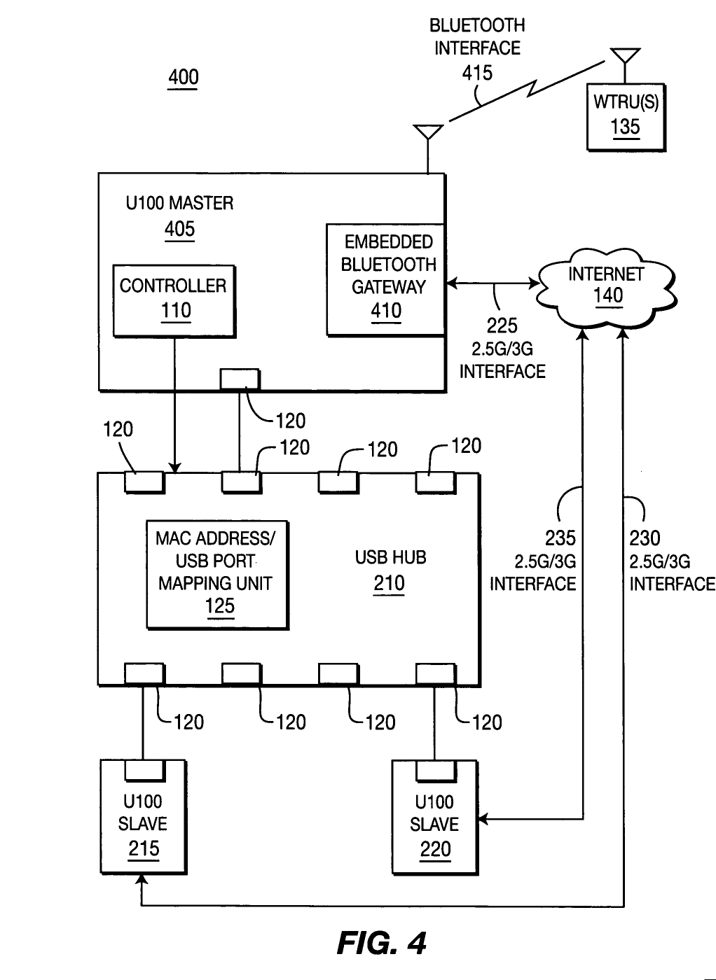

FIG. 4 is a block diagram of a system 400 similar to the system 200 of FIG. 2 except that a Bluetooth™ gateway 410 is embedding in a U100 master 405 to provide a Bluetooth™ interface 415 for at least one WTRU 135.

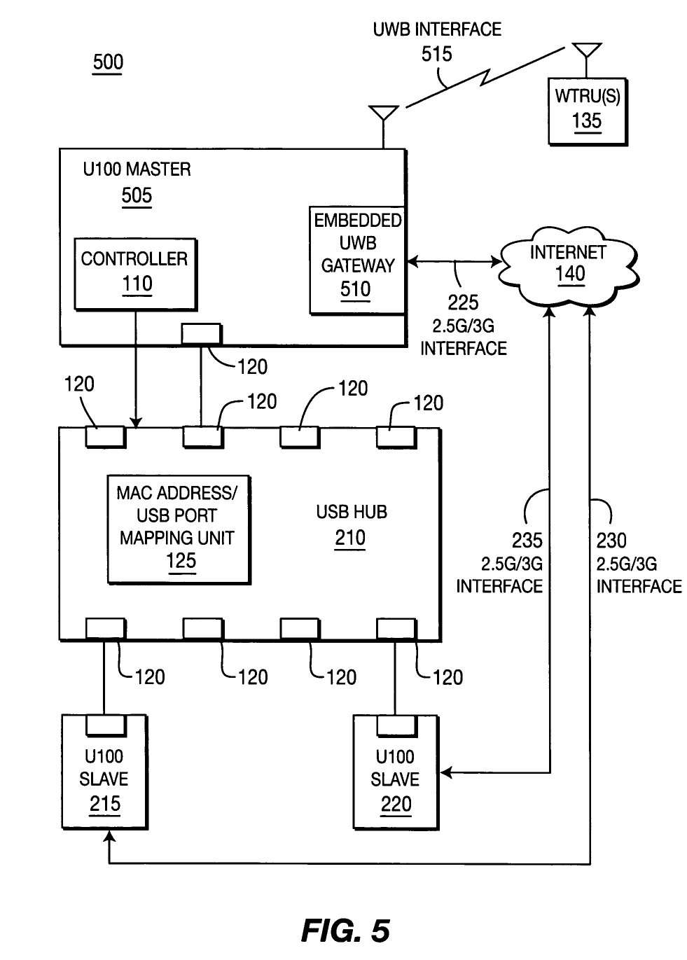

FIG. 5 is a block diagram of a system 500 similar to the system 200 of FIG. 2 except that it includes a UWB gateway 510 is embedded in a U100 master to provide a UWB interface 515 for at least one WTRU 135.

One problem of using a mobile platform WLAN interface as an AP is that battery life is significantly diminished, since a sleep mode cannot be implemented. This can be easily mitigated by necessitating the use of a battery charger during use when charging the WLAN AP 130. Additional power savings may be achieved by reducing the transmit power and reducing the coverage radius from 100 m to 5 m or 10 m, or by using lower data rates (1/2/5.5 Mbps) instead of 10 Mbps. The outgoing 3 G pipe is typically only 384 kbps.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A wireless communication system for providing users of wireless transmit/receive units (WTRUs) with access to the Internet, the system comprising:
(a) a short-range access point (AP) in communication with the WTRUs;
(b) a multiplexer in communication with the Internet and the AP; and
(c) a plurality of mobile platforms in communication with the multiplexer and the Internet.

2. The system of claim 1 wherein the AP is a wireless local area network (WLAN) AP.

3. The system of claim 1 wherein the AP operates in accordance with at least one IEEE 802.11 specification.

4. The system of claim 1 wherein the system further comprises:
(d) a mapping unit for storing a table of routable medium access control (MAC) addresses and mapping the MAC addresses to universal serial bus (USB) ports.

5. The system of claim 1 wherein the system provides the WTRUs with access to the Internet via a wireless local area network (WLAN) interface.

6. The system of claim 1 wherein the system provides the WTRUs with access to the Internet via a Bluetooth™ interface.

7. The system of claim 1 wherein the system provides the WTRUs with access to the Internet via an ultra-wideband (UWB) interface.

8. The system of claim 1 wherein the mobile platforms communicate with the Internet via a Third Generation (3G) interface.

9. The system of claim 1 wherein the multiplexer comprises:
(b1) a hardware router;
(b2) a controller in communication with the hardware router;
(b3) at least one Ethernet interface in communication with the hardware router and the WLAN AP; and
(b4) a plurality of universal serial bus (USB) ports, wherein each WTRU is provided with access to the Internet via a particular USB port as designated by the hardware router.

10. The system of claim 9 wherein the hardware router includes a medium access control (MAC)/USB port mapping unit.

11. A mass-transit vehicle having the system of claim 1 incorporated therein, wherein the WTRU users are passengers in the vehicle.

12. An integrated circuit (IC) for providing users of wireless transmit/receive units (WTRUs) with access to the Internet, the IC comprising:
(a) a short-range access point (AP) in communication with the WTRUs;
(b) a multiplexer in communication with the Internet and the AP; and
(c) a plurality of mobile platforms in communication with the multiplexer and the Internet.

13. The IC of claim 12 wherein the AP is a wireless local area network (WLAN) AP.

14. The IC of claim 12 wherein the AP operates in accordance with at least one IEEE 802.11 specification.

15. The IC of claim 12 wherein the system further comprises:
(d) a mapping unit for storing a table of routable medium access control (MAC) addresses and mapping the MAC addresses to universal serial bus (USB) ports.

16. The IC of claim 12 wherein the IC provides the WTRUs with access to the Internet via a wireless local area network (WLAN) interface.

17. The IC of claim 12 wherein the IC provides the WTRUs with access to the Internet via a Bluetooth™ interface.

18. The IC of claim 12 wherein the IC provides the WTRUs with access to the Internet via an ultra-wideband (UWB) interface.

19. The IC of claim 12 wherein the mobile platforms communicate with the Internet via a Third Generation (3G) interface.

20. The IC of claim 12 wherein the multiplexer comprises:
(b1) a hardware router;
(b2) a controller in communication with the hardware router;
(b3) at least one Ethernet interface in communication with the hardware router and the WLAN AP; and
(b4) a plurality of universal serial bus (USB) ports, wherein each WTRU is provided with access to the Internet via a particular USB port as designated by the hardware router.

21. The IC of claim 20 wherein the hardware router includes a medium access control (MAC)/USB port mapping unit.

22. A mass-transit vehicle having the IC of claim 12 incorporated therein, wherein the WTRU users are passengers in the vehicle.
